(19) United States
(12) Patent Application Publication
(10) Pub. No.: US 2024/0133216 A1
(43) Pub. Date: Apr. 25, 2024

(54) REUSABLE SYSTEM FOR SECURING PACKAGING AND PROVIDING TAMPER EVIDENCE

(71) Applicant: Ashish ANAND, Bangalore (IN)

(72) Inventors: Ashish ANAND, Bangalore (IN); Vandana ANAND, Bangalore (IN); Samridh ANAND, Bangalore (IN)

(73) Assignee: Ashish ANAND, Bangalore, KA (IN)

(21) Appl. No.: 18/568,863

(22) PCT Filed: Jun. 9, 2022
(86) PCT No.: PCT/IB2022/055403

§ 371 Date: Dec. 11, 2023

(30) Foreign Application Priority Data
Jun. 9, 2021 (IN) 202141025889
Jun. 21, 2021 (IN) 202141027868
Nov. 4, 2021 (IN) 202141050800
Nov. 16, 2021 (IN) 202141052437
Nov. 27, 2021 (IN) 202141054993
Dec. 3, 2021 (IN) 202141056237
Dec. 7, 2021 (IN) 202141056865
Dec. 16, 2021 (IN) 202141058676
Apr. 23, 2022 (IN) 202241024052
May 10, 2022 (IN) 202241027143

(51) Int. Cl. E05B 73/00

(52) U.S. Cl. CPC E05B 73/0029; G06V 20/40

(57) ABSTRACT

A reusable system for securing packaging and providing tamper evidence is disclosed. The system may comprise a housing for securing an opening of the packaging, an access controller operably engaged to the housing and a security member. The housing may comprise a lock, wherein release of the lock may enable opening of the packaging. The access controller may be configured to operably move relative to the housing to assume positions comprising an active position and an inactive position. In the active position, the lock is prevented from being released thereby preventing the opening of the packaging. In the inactive position, the lock is releasable thereby enabling the opening of the packaging. The movement of the access controller from the active position to the inactive position causes change in the security member, wherein the change is capable of detecting tampering.

### BACKGROUND OF THE INVENTION

Unless otherwise indicated herein, the materials described in this section are not prior art to the claims in this application and are not admitted to being prior art by inclusion in this section.

### FIELD OF THE INVENTION

The disclosed subject matter generally relates to the field of security labels, and more particularly but not exclusively, to the field of reusable security label system providing tamper evidence.

### PRIOR ART

Use of tamper evident systems is packaging and shipping industry is a norm that enables in identifying tampering of the packages by a malicious person. One of the most popular and most used tamper evident security system is tie tags. The tie tags work on the mechanism of ratchet-pawl mechanism wherein the tag is configured to move only in one direction within a lock. The tie tag is wound around the packaging and locked using the above-mentioned ratchet-pawl mechanism. The tie tag prevents access to the opening of the packaging when the tie tag is intact. Therefore, to open the packaging the tie tag is cut using a mechanical cutter and this cutting-off of the tie tag renders the tie tag to be not reused. In other words, the conventional tie tag based tamper evident systems are single use systems which increases the per-use cost. Further, these conventional tie tags are typically made using virgin plastic which further increases the cost and also not environment friendly due to its single use property.

Further, in the conventional tie tags, to determine the authenticity of the tie tag coupled to the packaging, the tie tag may be provided with a unique code generally in the form of alpha-numeric code. The validation of the unique code determines the authenticity of the tie tag. However, the unique code of the tie tag can be easily replicated and a new tie tag with the same unique code can be manufactured. Therefore, a malicious person may cut the tie tag and tamper the packaging and install a new replica tie tag with the same unique code and get away with tampering of the packaging. Therefore, the conventional tie tags do not offer any protection against counterfeiting of the tie tags.

Traditional tamper-evidence systems are destructive in nature. In other words, the conventional packaging/labelling/plastic-seals used to secure assets/documents are destructible upon opening and destruction indicates tamper-evidence. Destructive tamper evidence renders packaging single-use.

In view of this, there is a need for an improved non-destructive tamper evidence system such that security packaging can be made reusable optimising per-use cost along-with making those packaging environmentally sustainable.

### SUMMARY OF THE INVENTION

In an embodiment, a reusable system for securing packaging and providing tamper evidence is disclosed. The system may comprise a housing for securing an opening of the packaging, an access controller operably engaged to the housing and a security member. The housing may comprise a lock, wherein release of the lock may enable opening of the packaging. The access controller may be configured to operably move relative to the housing to assume positions comprising an active position and an inactive position. In the active position, the lock is prevented from being released thereby preventing the opening of the packaging. In the inactive position, the lock is releasable thereby enabling the opening of the packaging. The movement of the access controller from the active position to the inactive position causes change in the security member, wherein the change is capable of detecting tampering.

### BRIEF DESCRIPTION OF DRAWINGS

Embodiments are illustrated by way of example and not limitation in the figures of the accompanying drawings, in which like references indicate similar elements and in which:

FIGS. 1A and 1B illustrates a reusable system 100 for securing packaging and providing tamper evidence, in accordance with an embodiment.

FIG. 2 illustrates a reusable system 200 for securing packaging and providing tamper evidence, in accordance with an embodiment.

FIGS. 3A and 3B illustrate a reusable system 300 for securing packaging and providing tamper evidence, in accordance with an embodiment.

FIGS. 4A and 4B illustrate a reusable system 400 for securing packaging and providing tamper evidence, in accordance with an embodiment.

FIG. 5 illustrates a reusable system 500 for securing packaging and providing tamper evidence, in accordance with an embodiment.

FIG. 6 illustrates the security member 502 configured to be peeled-off, in accordance with an embodiment.

FIG. 7A and FIG. 7B illustrates a reusable system 700 for securing packaging and providing tamper evidence, in accordance with an embodiment.

FIG. 8 illustrates a system 800 for detecting tampering of the reusable system 700.

FIGS. 9A-9C illustrate a reusable system 900 for securing packaging and providing tamper evidence, in accordance with an embodiment.

FIG. 10 illustrates a reusable system 1000 for securing packaging and providing tamper evidence, in accordance with an embodiment.

FIGS. 11A-11B illustrates a reusable system 1100 for securing packaging and providing tamper evidence, in accordance with an embodiment.

FIG. 12 illustrates a reusable system 1200 for securing packaging and providing tamper evidence, in accordance with an embodiment.

FIGS. 13A-13B illustrates a reusable system 1300 for securing packaging and providing tamper evidence, in accordance with an embodiment.

FIGS. 14A-14B illustrates a tamper evident packaging system 1400, in accordance with an embodiment.

FIGS. 15A-15B illustrates a system for interlocking panels of a doublesided packaging, in accordance with an embodiment.

### DETAILED DESCRIPTION

The following detailed description includes references to the accompanying drawings, which form a part of the detailed description. The drawings show illustrations in accordance with example embodiments. These example embodiments, which may be herein also referred to as “examples” are described in enough detail to enable those skilled in the art to practice the present subject matter. However, it may be apparent to one with ordinary skill in the art, that the present invention may be practised without these specific details. In other instances, well-known methods, procedures and components have not been described in detail so as not to unnecessarily obscure aspects of the embodiments. The embodiments can be combined, other embodiments can be utilized, or structural, logical, and design changes can be made without departing from the scope of the claims. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

A reusable system for securing packaging and providing tamper evidence is disclosed. The system may comprise a housing for securing an opening of the packaging, an access controller operably engaged to the housing and a security member. The housing may comprise a lock, wherein release of the lock may enable opening of the packaging. The access controller may be configured to operably move relative to the housing to assume positions comprising an active position and an inactive position. In the active position, the lock is prevented from being released thereby preventing the opening of the packaging. In the inactive position, the lock is releasable thereby enabling the opening of the packaging. The movement of the access controller from the active position to the inactive position causes change in the security member, wherein the change is capable of detecting tampering.

In an embodiment, the access controller may be operably connected to the housing in the form of a slider, wherein the access controller may slide with respect to the housing.

In another embodiment, the access controller may be operably connected to the housing in the form of a pivot mechanism, wherein the access controller may pivot with respect to the housing.

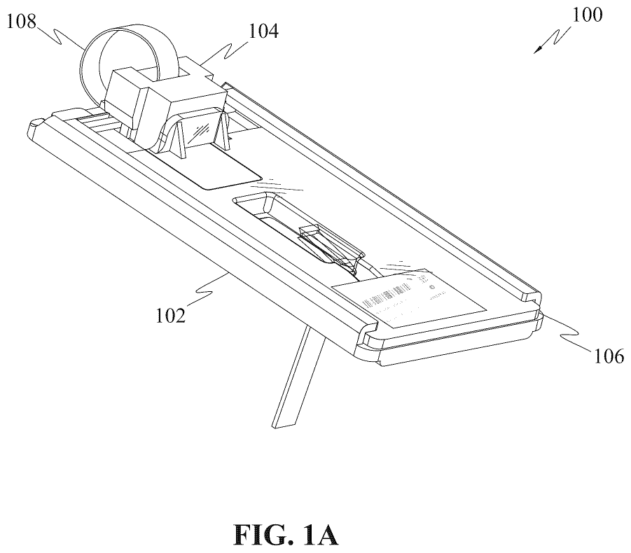

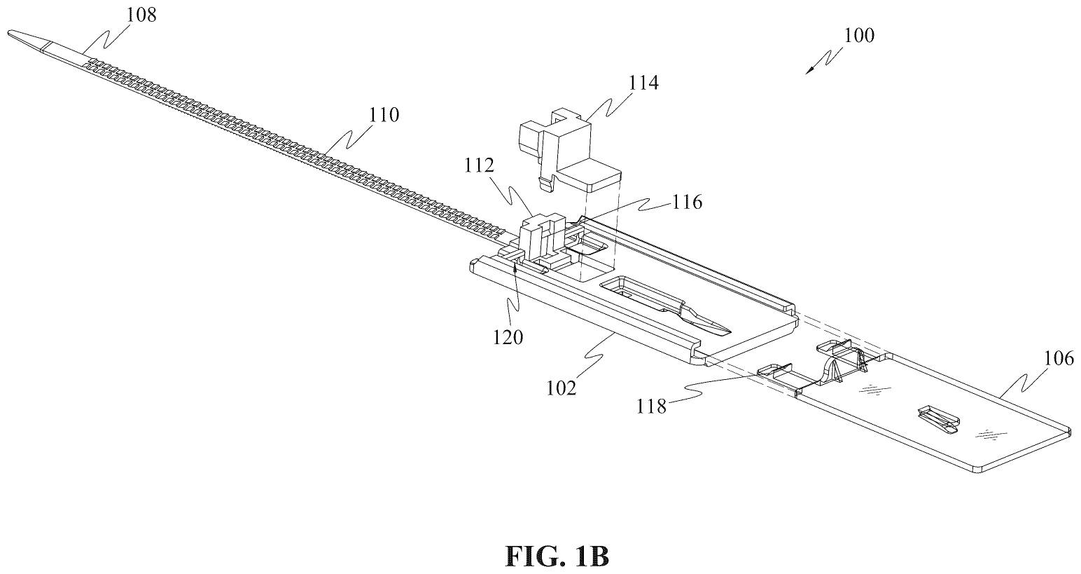

FIGS. 1A and 1B illustrates a reusable system 100 for securing packaging and providing tamper evidence, in accordance with an embodiment. The system 100 may comprise a housing 102, an access controller 106 and a security member. The housing 102 may comprise a tie 108 and a lock 104, wherein the tie 108 and the lock 104 may define a pawl-ratchet mechanism. The tie 108 may be operable to be moved in a first direction to secure the opening of the packaging and the tie 108 may be operable to be moved in a second direction to allow access to the opening upon the release of the lock 104.

In an embodiment, the tie 108 may extend from the housing 102, wherein the tie 108 may comprise a plurality of ridges 110 on its surface to define a ratchet of the pawl-ratchet mechanism. The lock 104 may comprise a first part 112 and a second part 114. The first part 112 may be defined on the housing 102 and the second part 114 may be releasably coupled to the housing 102 via the first part 112.

In an embodiment, the first part 112 and the second part 114 may be coupled with each other via a snap mechanism, pivot mechanism or the like.

The coupling of the first part 112 and the second part 114 may define a passage between the first part 112 and the second part 114. The passage may be defined in manner to receive the tie 108.

In an embodiment, a locking member 116 may be defined on an inner surface of the passage, wherein the locking member 116 may define a pawl of the pawl-ratchet mechanism.

An aperture may be defined on the housing 102 in a manner that the aperture is aligned with the passage formed between the first part 112 and the second part 114.

The housing 102 may comprise a pair of channels for slidably receiving the access controller 106, wherein the access controller 106 may be moved in a first direction to assume an active position and may be moved in a second direction to assume an inactive position.

The access controller 106 may be coupled to the housing 102 via a snapping mechanism comprising a male part 118 and a female part 120.

During its locking operation, the tie 108 may secure the opening of the packaging and the tie 108 may be locked using the lock 104, wherein the free end of the tie 108 may be traversed into the passage defined between the first part 112 and the second part 114. The locking member 116 defined on the passage may interlock with the ridges 110 on the tie to 108 prevent the tie from traversing out of the lock 104. The free end may further exit via the aperture formed on the housing 102. Finally, the access controller 106 along with the tamper-evident security member may be engaged to the housing 102 to assume the active position to prevent the release of the lock 104.

During its unlocking operation (release of the lock), the tie 108 can only be released from the lock 104 by disengaging the second part 114 from the first part 112 of the lock 104. In order for the second part 114 to be disengaged from the first part 112 to release the lock 104, firstly the access member 106 must be moved from the active position to the inactive position. The access member 106 may be disengaged from the housing 102 to enable the disengagement of the second part 114 from the first part 112 of the lock 104. The disengagement of the access member 106 from the housing 102 may cause the access member 106 to assume the inactive position to release the lock 104. The movement of the access member 106 from the active position to the inactive position may cause a change in the security member, wherein the change is capable of detecting tampering. Therefore, any unauthorised opening of the packaging may be detected by the change in the security member caused by the release of the lock.

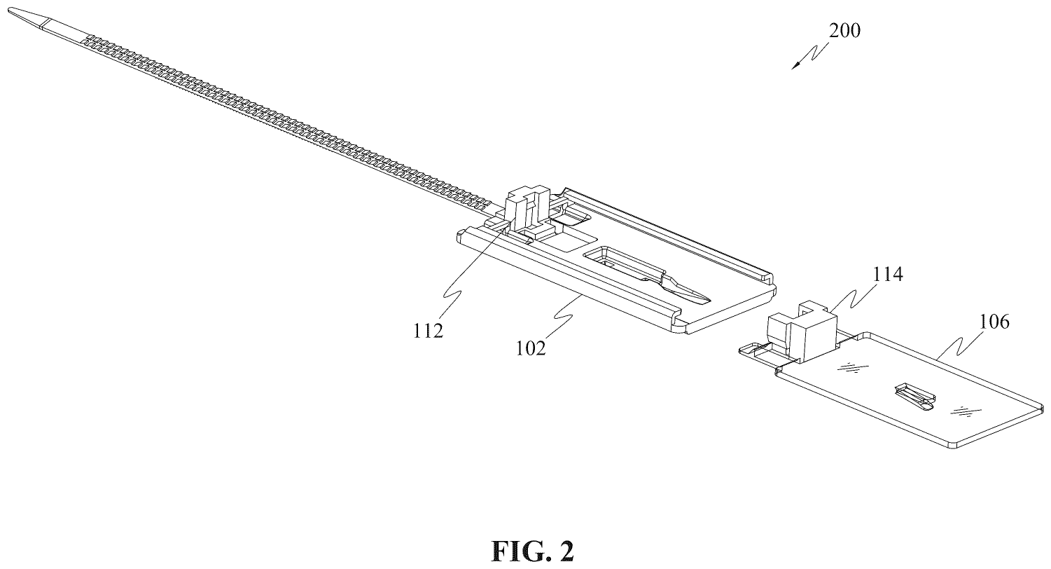

FIG. 2 illustrates a reusable system 200 for securing packaging and providing tamper evidence, in accordance with an embodiment. The second part 114 may be integrally defined on the access controller 106. The access controller 106 may be configured to be releasably coupled to the first part 112 via the second part 114. The coupling of the access controller 106 with the first part 112 may define the lock 104, wherein the passage may be formed between the second part 114 and the first part 112 upon engagement of the access controller 106 with the first part 112. The locking member 116 defined on the passage may interlock with the ridges 110 on the tie 108 to prevent the tie from traversing out of the lock 104. The free end may further exit via the aperture formed on the housing 102. Finally, the access controller 106 along with the tamper-evident security member may be engaged to the first part to assume the active position to prevent the release of the lock.

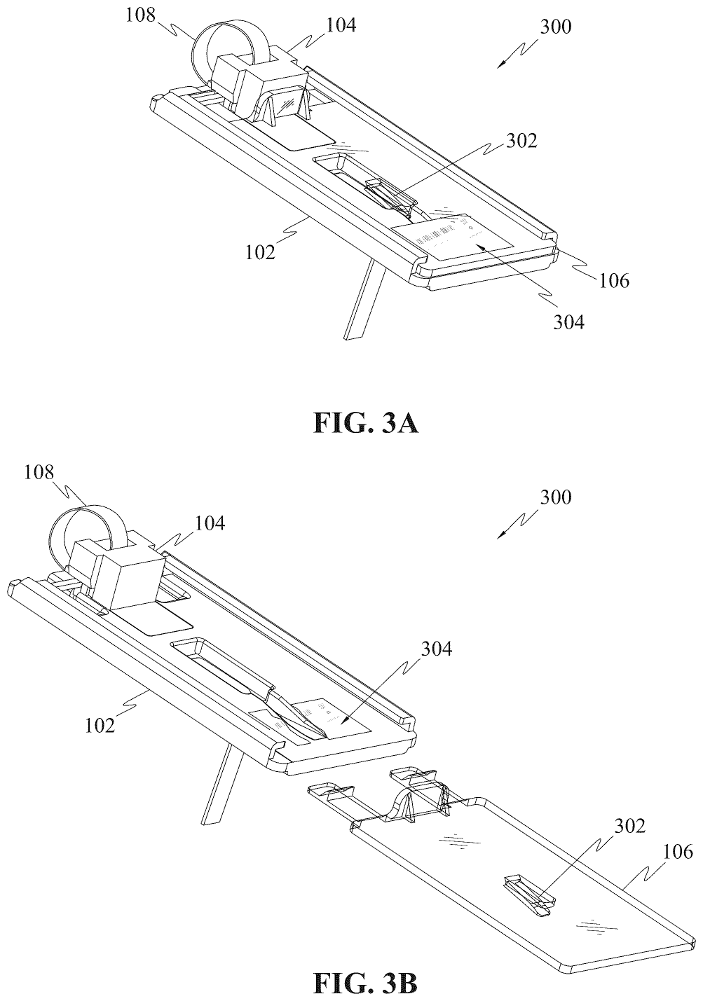

FIGS. 3A and 3B illustrate a reusable system 300 for securing packaging and providing tamper evidence, in accordance with an embodiment. The system 300 may be configured to provide tamper evidence by the way of tearing-off of a portion of a tamper-evident security member 304 upon the movement of the access controller 106 from the active position to the inactive position. The security member 304 may be disposed between the housing 102 and the access controller 106. The access controller 106 may comprise a protruding member 302 protruding in a direction towards the security member 304. The movement of the access controller 106 from the active position to the inactive position may cause the protruding member 302 to tear-off at least a portion of the security member 304 thereby indicating tampering.

In one embodiment, the housing 102 may comprise a pair of channels to receive the access controller 106. The access controller 106 may be slidably engaged to the housing 102. The access controller 106 may be slid in a first direction for the access controller 106 to assume the active position and the access controller 106 may be slid in a second direction for the access controller to assume the inactive position.

In one embodiment, the security member 304 may be adhesively coupled to a first surface of the housing 102 that is beneath the access controller 106. In an alternate embodiment, the security member 304 may be a liner-less, non-adhesive label such as to optimize cost and making labels more environmentally sustainable.

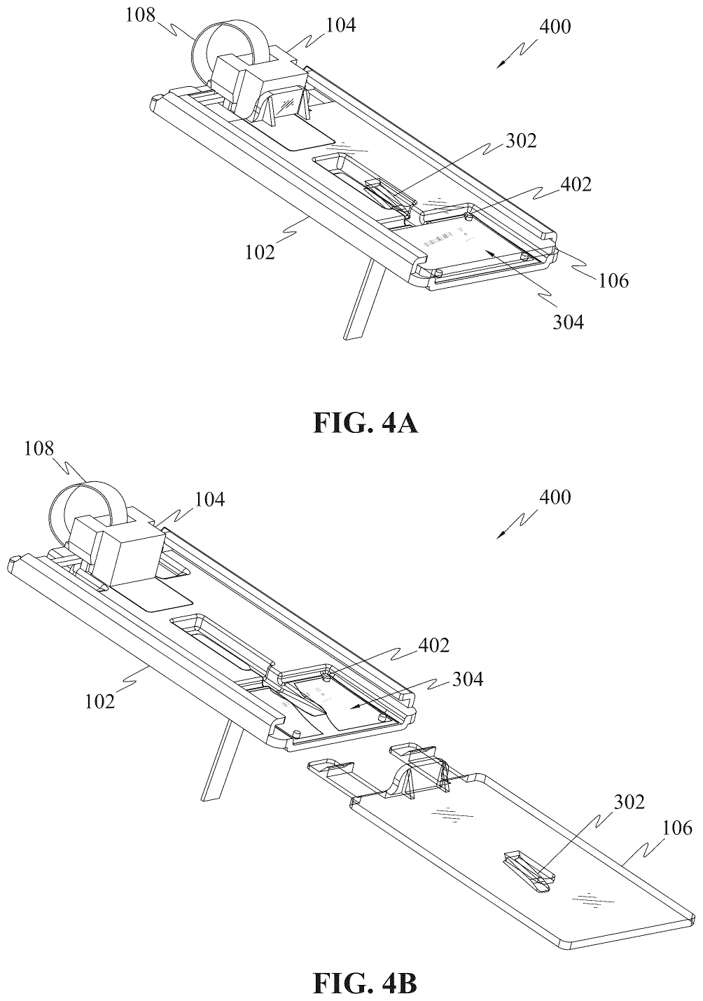

FIGS. 4A and 4B illustrate a reusable system 400 for securing packaging and providing tamper evidence, in accordance with an embodiment. A first surface of the housing that is beneath the access controller may define at least a pair of raised studs 402. The security member 304 may define at least of pair of holes configured to receive the pair of studs 402. Thus, the security member 304 may be engaged with the housing via the pair of studs 402 and the pair of holes.

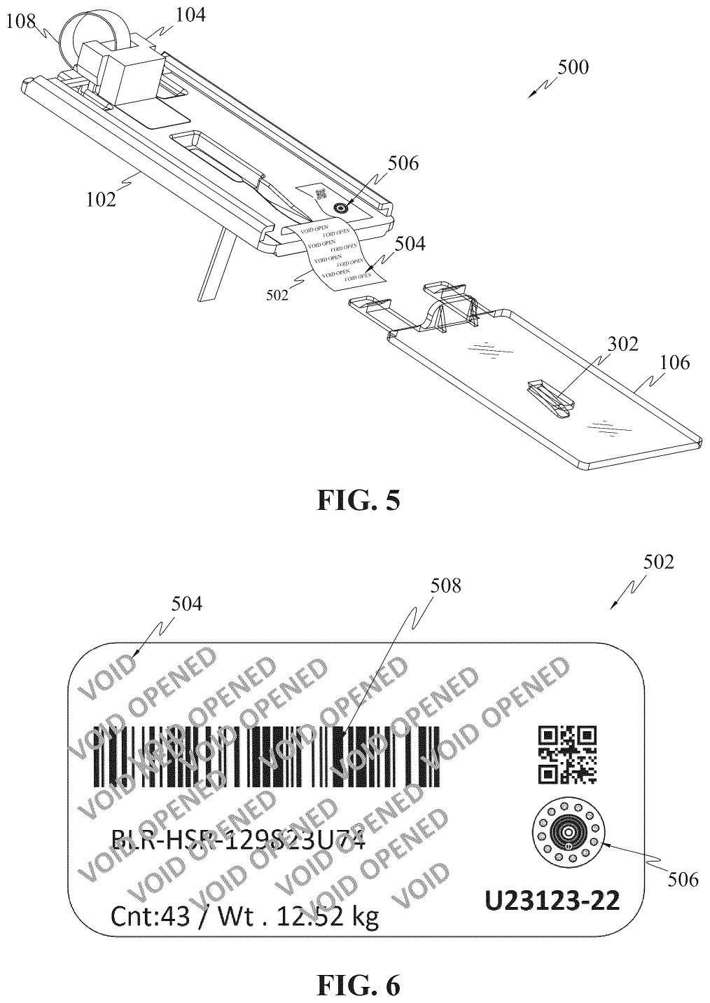

FIG. 5 illustrates a reusable system 500 for securing packaging and providing tamper evidence, in accordance with an embodiment. The system 500 may be configured to provide tamper evidence by the way of peeling-off of a portion of a security member 502 upon the movement of the access controller 106 from the active position to the inactive position. The security member 502 may be disposed between the housing 102 and the access controller 106 and adhesively coupled to a first surface of the housing 102. The access controller 106 may comprise a protruding member 302 protruding in a direction towards the security member 502. The movement of the access controller 106 from the active position to the inactive position may cause the protruding member 302 to peel-off at least a portion of the security member 502 thereby indicating tampering. The peeled-off portion of the security member 502 may leave visible tamper evident markings 504 indicating tampering.

FIG. 6 illustrates the security member 502 configured to be peeled-off, in accordance with an embodiment. The security member 502 may comprise tamper-evident markings 504, a tracking code 508, and a unique non-clonable code 506. The markings 504 may be configured to be revealed only upon peeling off of the security member 502 from a packaging. The unique non-clonable code 506 may relate to an information associated with the packaging. The unique non-clonable code 506 may be positioned in a manner that the unique non-clonable code 506 is undistorted or may remain intact upon peeling-off of the security member 502 by the protruding member 302.

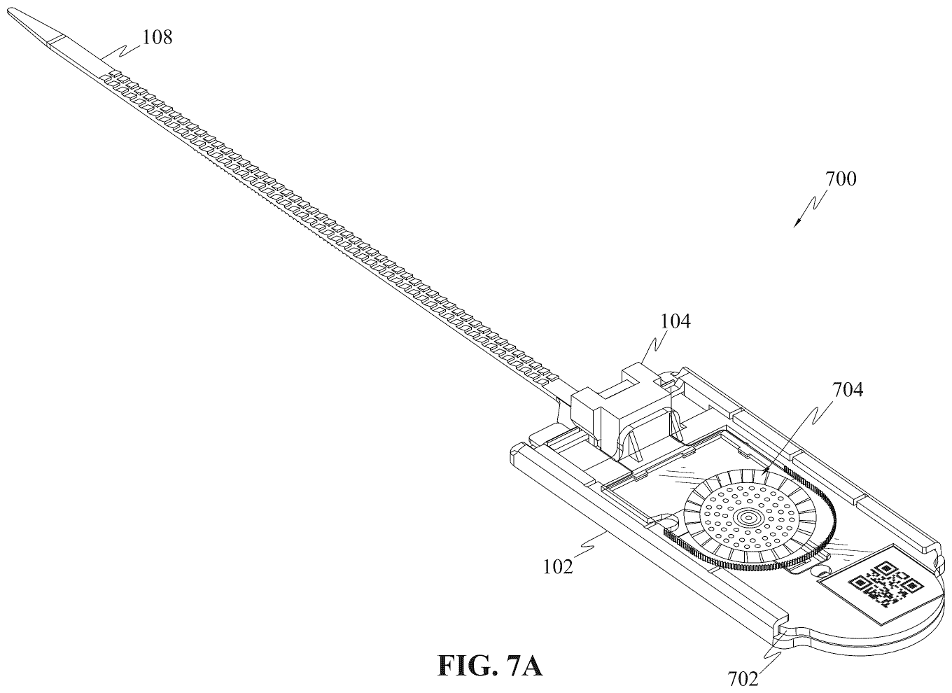

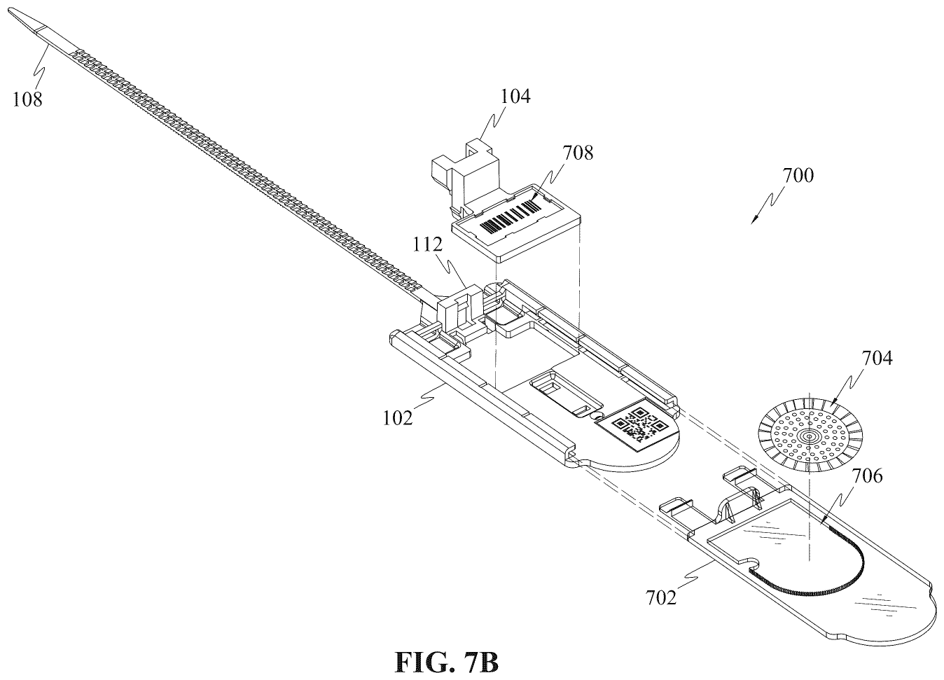

FIG. 7 illustrates a reusable system 700 for securing packaging and providing tamper evidence, in accordance with an embodiment. The system 700 may comprise a security member 704, an access controller 702, a housing 102, and an external reference 710. The security member 704 may comprise a pattern 712 that is configured to be digitally scanned. The security member 710 may be disposed between the access controller 702 and the housing 102, wherein the access controller 702 may define a depression 706 on a surface facing the housing 102 to receive the security member 704.

In an embodiment, the access controller 702 may be made using a transparent material such that the pattern on the security member 704 is visible through the access controller 702.

The external reference 710 may be disposed on a surface that is independent of the security member 704, wherein the pattern is at a spatial orientation with respect to the external reference 710.

A label 708 may be disposed between the housing and the access controller, wherein the label 708 may comprise an information relating to the packaging.

In one embodiment, the label 708 may be a liner-less, non-adhesive label such as to optimize cost and making labels more environmentally sustainable

As explained, during locking operation, the tie 108 is secured with the opening and the locked in the lock 104. The access controller 702 along with the security member 704 comprising the machine-scannable pattern is engaged to the housing 102 in the active position to prevent the release of the lock 104. The pattern may be at a first spatial orientation with the external reference 710 upon the access controller 702 assuming the active position.

During unlocking operation, the access controller 702 may be disengaged from the housing 102 to enable the disengagement of the second part 114 from the first part 112 to release the lock 104. The movement of the access controller 702 from the active position to the inactive position to enable the release of the lock 104 causes the change in the spatial orientation between the pattern and the external reference 710. This change in the spatial orientation between the pattern and the external reference 710 enables the detection of tampering.

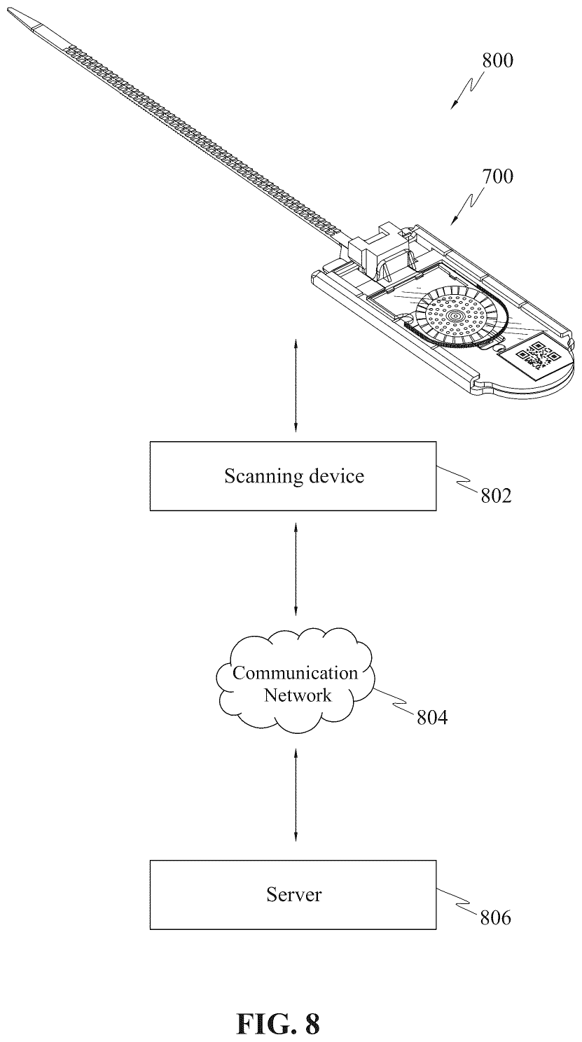

FIG. 8 illustrates a system 800 for detecting tampering of the reusable system 700. The system 800 may comprise a scanning device 802, a communication network 804, and a server 806, wherein the scanning device 802 may scan the first spatial orientation between the pattern and the external reference 710 and store the first spatial orientation of the pattern relative to the external reference 710 on the server 806 along with a unique information associated with the packaging.

In one embodiment, the server 806 may be remote server or a local server.

In one embodiment, the communication network 804 may be a wireless network or a wired network.

Further, the scanning device 802 may scan the spatial orientation between the pattern and the external reference 710 at any point in time after securing the packaging. The scanning device 802 may retrieve the first spatial orientation stored on the server based on the unique information associated with the packaging.

The scanning device 802 may indicate tampering if the spatial orientation between the pattern and the external reference 710 at any point in time after securing the packaging does not match the first spatial orientation.

In an embodiment, the scanning device may be a mobile device, a camera a smart phone or the like.

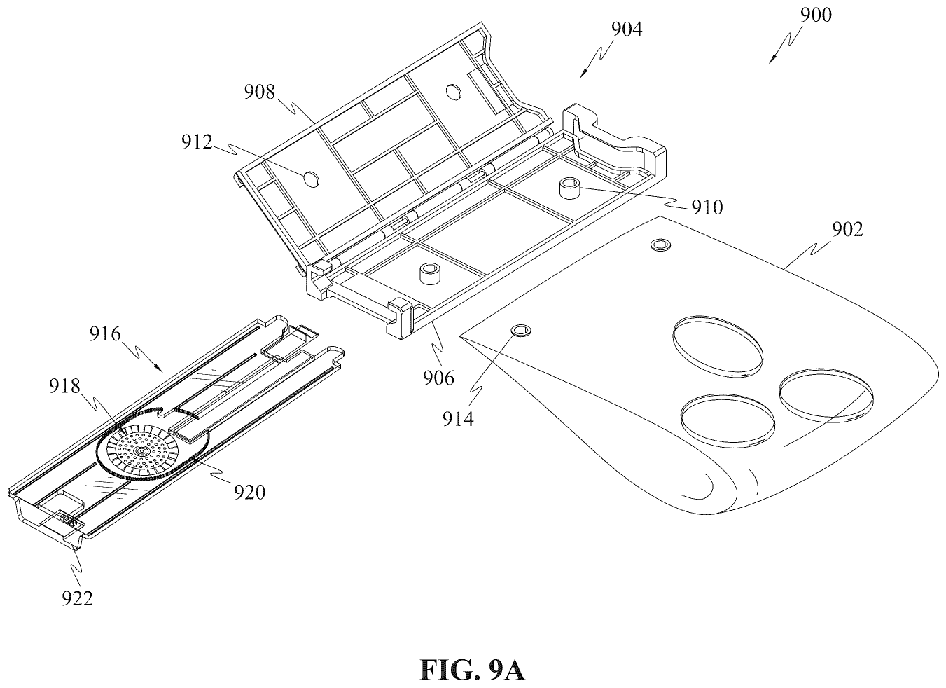

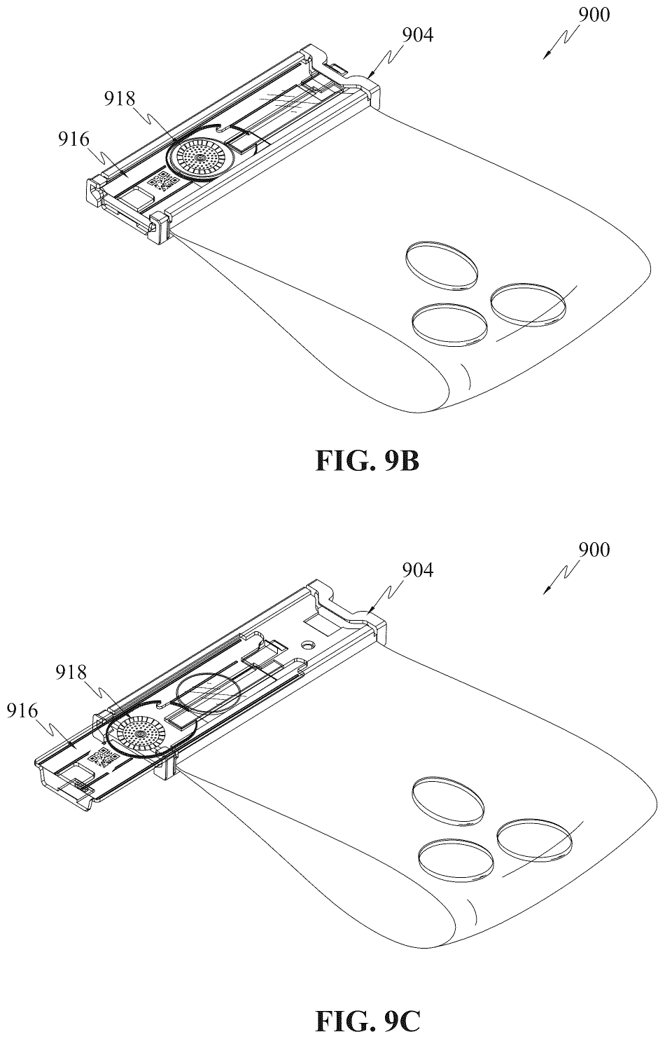

FIGS. 9A-9C illustrate a reusable system 900 for securing packaging and providing tamper evidence, in accordance with an embodiment. The system 900 may be configured to offer protection for packaging 902 in the form of pouch. The housing 904 may comprise a first panel 906 and a second panel 908, wherein the first panel 906 is engaged with the second panel 908. The first panel 906 may comprise at least a pair of protrusions 910 protruding from a surface of the first panel 906 towards the second panel 908.

The second panel 908 may comprise a pair of cavities 912 configured to receive the protrusions 910, and a pair of channels to receive the access controller 916. The second panel 908 may be hinged to the first panel 906 such that the second panel 908 may assume positions comprising an open position and a closed position. In the open position, the second panel 908 enables access to the protrusions 910 and in the closed position the second panel 908 prevents access to the protrusions 910.

The packaging 902 may comprise a pair of eyelets 914 configured to receive the eyelets 914, wherein the opening of the packaging may be secured by engaging the eyelets 914 of the packaging with the protrusions 910. Upon engaging the eyelets with the protrusions, the second panel 908 may be flipped pivotally towards the first panel 906 to assume the closed position thereby securing the opening of the packaging.

The access controller 916 may be slidably coupled to the second panel 908 in the closed position via the pair of channels. The second panel 908 may be moved to the open position inly upon disengagement of the access controller 916 from the second panel 908. For ease in understanding, the access controller is shown in sliding format in an embodiment, but invention can be exercised by various means of coupling access controller with second panel for example access controller can be in rotatory form.

In an embodiment, the access controller 916 may comprise a locking joint 922 defined on a surface extending beneath the first panel and the first panel may define a locking portion. The locking joint 922 may interlock with the locking portion to define a lock 104. Upon locking, the second panel 908 is prevented from assuming an open position when the access controller 916 is still engaged with the second panel 908.

The system 900 may further comprise a security member 918 and an external reference. The security member 918 may comprise a pattern that is configured to be digitally scanned. The security member 918 may be disposed between the access controller 916 and the housing 904, wherein the access controller may define a depression 920 on a surface facing the housing 904 to receive the security member 918.

In an embodiment, the access controller 916 may be made using a transparent material such that the pattern on the security member 918 is visible or scannable through the access controller 916. Though Embodiment is illustrated with a security member in form of a reusable tag that changes its spatial orientation upon operating the access controller but in simplified embodiment operating access controller can also manifest in form of tearing or peeling of a security label (either self-adhesive or non self-adhesive) protected with access controller and similar scheme is shown in FIGS. 3A, 3B, 4A, 4B and 5. Simplified embodiment does not require scanning each time reusable module is closed.

The external reference may be disposed on a surface that is independent of the security member 918, wherein the pattern is at a spatial orientation with respect to the external reference.

As explained, during locking operation, the housing 904 is secured with the opening and the locked in the lock. The access controller 916 along with the security member 918 comprising the machine-scannable pattern is engaged to the housing 904 in the active position to prevent the release of the lock. The pattern may be at a first spatial orientation with the external reference upon the access controller 916 assuming the active position.

During unlocking operation, the access controller 916 is disengaged from the housing 904 to enable the release the lock. The movement of the access controller 916 from the active position to the inactive position to enable the release of the lock causes the change in the spatial orientation between the pattern and the external reference. This change in the spatial orientation between the pattern and the external reference enables the detection of tampering.

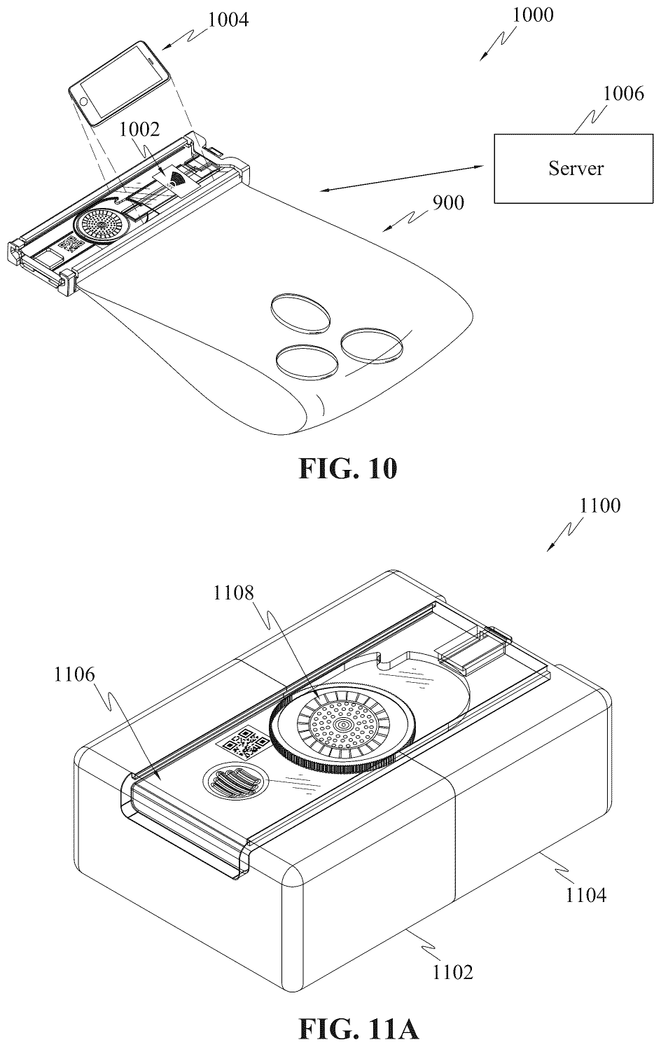

FIG. 10 illustrates a reusable system 1000 for securing packaging and providing tamper evidence, in accordance with an embodiment. The system 1000 may comprise a NFC (near field communication) tag 1002, a NFC enabled device 1004 and a server 1006. The NFC enabled device 1004 may comprise a GPS module. The NFC enabled device 1004 may be placed in close proximity to the NFC tag 1002 and may be in constant or periodic communication with the NFC tag 1002 to collect information from the NFC tag 1002. Further, the NFC enabled device 1004 may also be in communication with the server 1006, wherein the server 1006 may receive geographical information from the GPS module and the NFC tag 1002 information from the NFC enabled device 1004.

The movement of the NFC enabled device 1004 away from the NFC tag causes a break in the communication between the NFC enabled device and the NFC tag. The server 1006 may record the break in the communication between the NFC enabled device 1004 and the NFC tag 1002 and raise an alarm.

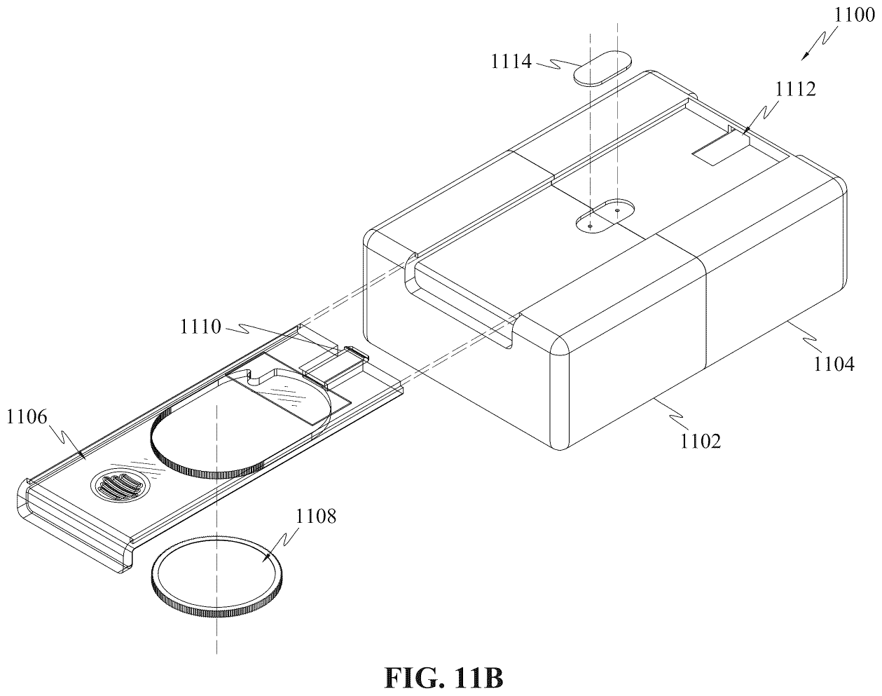

FIGS. 11A-11B illustrates a reusable system 1100 for securing packaging and providing tamper evidence, in accordance with an embodiment. The housing may comprise a male unit 1102 and a female unit 1104, wherein the male unit 1102 is configured to be coupled to the female unit 1104 to define a closed space.

In one embodiment, the male unit 1102 and the female unit 1104 may comprise interlocking portions that defines the lock.

In one embodiment, the male unit 1102 and the female unit 1104 may be coupled with each other using a connector 114.

Further, the access controller 1106 may be slidably coupled to the housing in a manner that the engagement of the access controller 1106 to the housing (active position) prevents the disengagement of the male unit 1102 and the female unit 1104. The access controller is shown in sliding format in embodiment but invention can be exercised by various means of coupling access controller for example access controller can be in rotatory form interconnecting both male and female unit of box.

Further, disengagement of the access controller 1106 from the housing (inactive position) may enable the male unit 1102 and the female unit 1104 to be disengaged to access the opening of the packaging.

The disengagement of the access controller 1106 may cause the access controller 1106 to move to the inactive position thereby causing the change in the security member 1108 to detect tampering.

The change in the security member 1108 may be in any of the forms as discussed earlier, viz., tear-off, peel-off, change in spatial orientation of the pattern or the like. For sake of conciseness, an embodiment is illustrated with Security member in form of a reusable tag that changes its spatial orientation upon operating the access controller but in simplified embodiment operating access controller can also manifest in form of tearing or peeling of a security label (either self-adhesive or Non self-adhesive) protected with access controller and similar scheme is shown in FIGS. 3A, 3B, 4A, 4B and 5. Simplified embodiment does not require scanning each time reusable module is closed.

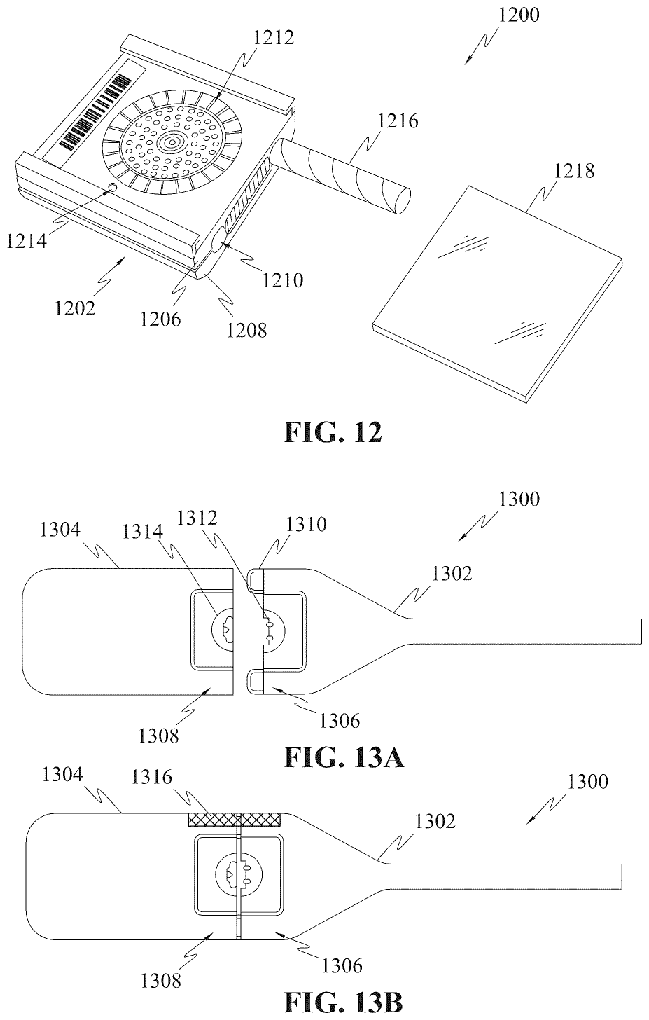

FIG. 12 illustrates a reusable system 1200 for securing packaging and providing tamper evidence, in accordance with an embodiment. The housing 1208 may be defined as a hinge comprising a first plate 1206 and a second plate 1208. The second plate 1208 may be hinged with the first plate 1206 along an edge. The first plate 1206 and the second plate 1208 may be locked together using a lock.

In one embodiment, the lock may be a locking pin, clamp or the like with sole purpose of coupling plates together. For conciseness, embodiment is described using example of locking-pin.

In one embodiment, the first plate 1206 may define a first pair of grooves and a first hole. The second plate 1208 may define a second pair of grooves and a second hole.

When the hinge is closed, the first pair of grooves and the second pair of grooves may align with each other to define a pair of cavities 1210, and the first hole and the second hole may align with each other to define a pinhole 1214.

The pair of cavities 1210 may be configured to receive a wire 1216 and the pinhole 1214 may be configured to receive a locking pin to define the lock.

An exterior surface of the housing 1208 may define a pair of channels for receiving the access controller 1218.

The system 1200 may further comprise a security member 1212 and an external reference 1214. The security member 1212 may comprise a pattern that is configured to be digitally scanned. The security member 1212 may be disposed between the access controller 1218 and the exterior surface of the housing 1208, wherein the access controller 1218 may define a depression on a surface facing the housing to receive the security member 1212.

In an embodiment, the access controller 1218 may be made using a transparent material such that the pattern on the security member 1212 is visible through the access controller.

The external reference 1214 may be disposed on a surface that is independent of the security member 1212, wherein the pattern is at a spatial orientation with respect to the external reference 1214.

As explained, during locking operation, the locking pin is placed inside the pinhole 1214 to lock the hinge. The access controller 1218 along with the security member 1212 comprising the machine-scannable pattern is engaged to the exterior surface of the housing in the active position to prevent the release of the locking pin. The pattern may be at a first spatial orientation with the external reference upon the access controller 1218 assuming the active position.

During unlocking operation, the access controller 1218 is disengaged from the housing to enable the disengagement of the locking pin to release the lock. The movement of the access controller 1218 from the active position to the inactive position to enable the release of the locking pin causes the change in the spatial orientation between the pattern and the external reference. This change in the spatial orientation between the pattern and the external reference enables the detection of tampering.

FIGS. 13A-13B illustrates a reusable system 1300 for securing packaging and providing tamper evidence, in accordance with an embodiment. The system 1300 may comprise a tie tag device 1318 and a security member 1316. The tie tag device 1318 may comprise a tag 1304 and a tie 1302 configured to be connected with each other. The tie 1302 may comprise a first portion 1306, wherein the first portion 1306 may further define a first slot 1312 and a first locking clip 1310. The tie 1302 may comprise a plurality of ridges. The tag 1304 may comprise a second portion 1308, wherein the second portion 1308 may further define a second slot 1314 and a first recess.

The tag 1304 and the tie 1302 may be coupled with each other between the first portion 1306 and the second portion 1308 by interlocking the first locking clip 1310 and the first recess. Upon engagement of the tie 1302 and the tag 1304, the first slot 1312 and the second slot 1314 may align with each other to define a receiving space for receiving a free end of the tie.

Further, a locking member may be defined on an inner surface of the receiving space formed between the first slot and the second slot. The ridges on the tie may interlock with the locking member on the receiving space to prevent the tie traversing out of the receiving space.

The security member 1316 may be engaged to the tie tag device upon engagement of the tag 1304 and the tie 1302 with each other. The security member 1316 may be engaged in a manner that the disengagement of the tag 1304 and the tie 1302 may cause a change in the security member 1316, wherein the change is capable of detecting tampering.

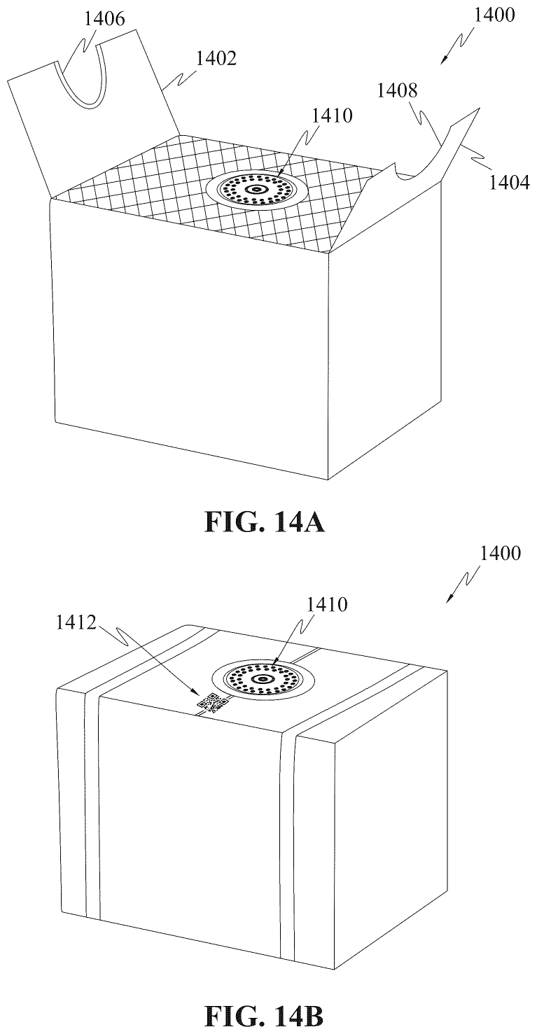

FIGS. 14A-14B illustrates a tamper evident packaging system 1400, in accordance with an embodiment. The system may comprise a packaging 1400, a security member 1410, an external reference 1412.

In one embodiment, the packaging may be defined as a box to hold an item. The packaging may comprise an opening side that may be configured to provide access into the packaging. The opening side may further comprise a first closing flap 1402 and a second closing flap 1404, wherein when the first closing flap 1402 and the second closing flap 1404 are coplanar, the opening side assumes a closed position.

The first closing flap 1402 may comprise a first cut-out portion 1406 and the second closing flap 1404 may comprise a second cut-out portion 1408, wherein the first cut-out portion 1406 and the second cut-out portion 1408 may align with each other to define a receiving space that may enable access to an interior volumetric region of the packaging.

The first cut-out portion 1406 may define a first ledge on the periphery of the first cut-out portion 1406 and the second cut-out portion 1408 may define a second ledge on the periphery of the second cut-out portion 1408.

The security member 1410 comprising a machine scannable pattern may be placed in the receiving space in a manner that the security member 1410 may be sandwiched between the item that is inside the interior volumetric region of the packaging, and the first ledge and the second ledge. Purpose of ledge is to keep security member spatially intact during transit and as required security member can also have ledge.

The perimeter of the receiving space may be smaller than the perimeter of the security member 1410 to prevent the movement of the security member 1410.

The external reference 1412 may be disposed on a surface that is independent on the security member 1410, wherein the external reference 1412 is at a first spatial orientation with respect to the pattern.

In one embodiment, the packaging may be strapped using a strap for securing the package and the security member.

In one embodiment, the security member may be stapled with the package for securing the security member.

During its operation, any tampering of the packaging to access the item inside the packaging may result in disturbing the spatial orientation of the pattern with the external reference thereby indicating tampering.

The system 1400 may further be configured to trigger a video auditing of the packaging along with the scanning of the security label.

In an embodiment, the system may comprise a video capturing device configured to capture the video of the packaging for the audit. The video capturing device may be triggered to capture the video of all the sides and the edges of the packaging along with the scanning of the security member. The system further comprises a server that may be in communication with the video capturing device. The video capturing device may send the captured video to the server which may audit the received video to determine the tampering.

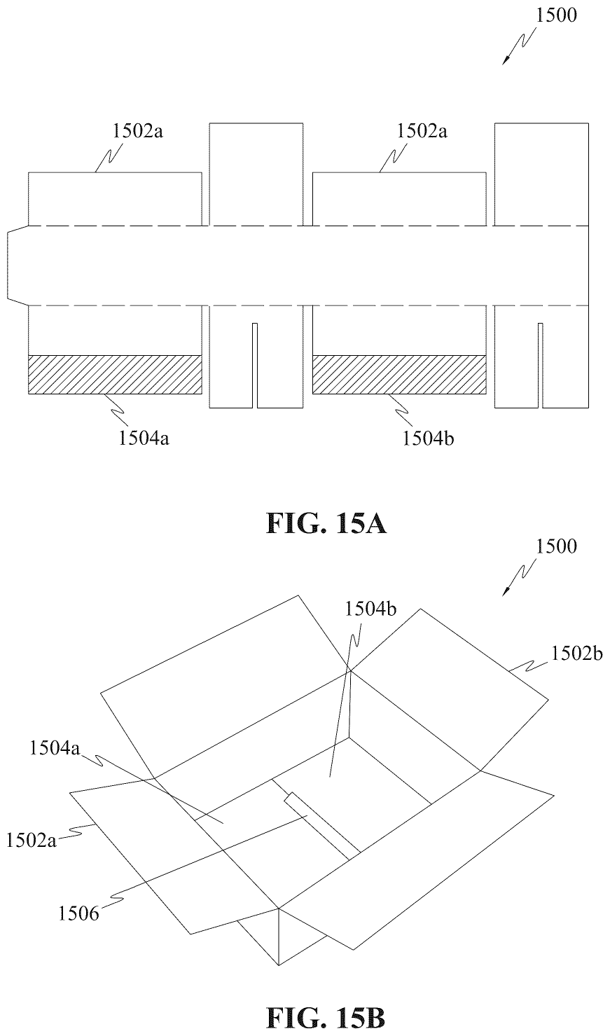

FIGS. 15A-15B illustrates a system for interlocking panels of a double sided packaging, in accordance with an embodiment.

The packaging 1500 comprises may comprise closing side comprising double flaps (1504a and 1504b) opposite to the opening side (1502a and 1502b). The closing side flaps (1504a and 1504b) may comprises a third extended fold 1504a and a fourth extended fold 1504b. A portion of the third extended fold 1504a may be bent inwardly towards the volumetric space of the packaging 1500 and a portion of the fourth extended fold 1504b may be bent inwardly towards the volumetric space of the packaging. Further, the inwardly bent portions of the third extended fold 1504a and the fourth extended fold 1504b may be engaged from the interior the volumetric space of the packaging to secure the opening of the closing side. Extended portions of both sides of closing flaps can be interlocked either by snap-lock or stapling or other traditional means. The advantage of folding the flaps inwards is that any malicious access from bottom of the box requires an evident-cut in board (or corrugated sheet) material unlike just doing tape-cut and reapplying the tape once gain. This evident cut can be detected in a video audit where one single scan happens for security member on top-side and bottom side integrally along with other sides/edges gets captured in a single video audit triggered along with the scanning of the security member.

In an embodiment, a unique non-clonable label may be engaged to a packaging which may be linked with the security member.

The invention (reusable security systems) disclosed herein can be performed with multiple variations, those will be evident to the person having ordinary skill in art without undue experimentation. All possible variations are not described here such as not to obscure the invention disclosure. For example, some of possible variation are captured below:

In an embodiment, either or both parts (lock and sliders) may be integrated together with the seal.

In one embodiment, a strap-tunnel (passage and lock) may be locked by a rotatory motion of seal-lock (access controller) instead of horizontal or vertical insert (second part).

In one embodiment, the implementation of access controller in form rotatory part sandwiching the security member/spatial orientation tag instead of access controller shown in form of slider that slides in c-channel as illustrative embodiment.

In one embodiment, instead of label getting torn on pull-out of slider implementing a peel-able label that leaves tamper-evident mark as well on seal-base.

The processes described above is described as a sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A reusable system for securing packaging and providing tamper evidence, the system comprising:
a housing securing an opening of the packaging, the housing comprising a lock, wherein release of the lock enables opening of the packaging;
an access controller operably engaged to the housing, the access controller operable to be moved relative to the housing to assume positions comprising an active position and an inactive position, wherein,
in the active position, the lock is prevented from being released; and
in the inactive position, the lock is releasable; and
a security member, wherein the movement of the access controller from the active position to the inactive position causes change in the security member, wherein the change is capable of detecting tampering.

2. The system as claimed in claim 1, wherein:
the security member is disposed between the housing and the access controller;
the access controller is engaged to the housing and comprises a protruding member protruding in a direction towards the security member; and
the movement of the access controller from the active position to the inactive position causes the protruding member to tear-off at least a portion of the security member thereby indicating tampering.

3. The system as claimed in claim 2, wherein the security member is adhesively coupled to a first surface of the housing that is beneath the access controller.

4. The system as claimed in claim 2, wherein:
a first surface of the housing that is beneath the access controller defines at least a pair of raised studs; and
the security member defines at least a pair of holes configured to receive the studs to engage the security member with the housing such that label gets torn upon the access controller moving from the active position to the inactive position.

5. The system as claimed in claim 1, wherein:
the security member is disposed between the housing and the access controller, and is adhesively coupled to a first surface of the housing that is beneath the access controller;
the access controller is engaged to the housing and comprises a protruding member protruding in a direction towards the security member; and
the movement of the access controller from the active position to the inactive position causes the protruding member to peel-off at least a portion of the security member, wherein the peeled-off portion of the security member leaves visible markings thereby indicating tampering.

6. The system as claimed in claim 5, wherein the security member comprises a unique non-clonable code relating to an information associated with the packaging, wherein the portion of the member having unique non-clonable code remains intact and is undistorted upon peeling-off of the security member by the protruding member.

7. The system as claimed in claim 1, wherein:
the security member is disposed between the housing and the access controller, wherein the security member comprises a pattern that is configured to be digitally scanned;
the access controller is made using a transparent material such that the pattern on the security member is visible through the access controller;
an external reference is disposed on a surface that is independent of the security member, wherein the external reference is at a first spatial orientation with respect to the pattern when the access controller is the active position; and
the movement of the access controller from the active position to the inactive position causes change in the spatial orientation between the pattern and the external reference to a second spatial orientation.

8. The system as claimed in claim 7, wherein the system comprises:
a scanning device configured to:
scan the first spatial orientation between the pattern and the external reference upon securing the packaging;
scan the spatial orientation between the pattern and the external reference at any point in time after securing the packaging; and
indicate tampering if the spatial orientation between the pattern and the external reference at any point in time after securing the packaging does not match the first spatial orientation.

9. The system as claimed in claim 1, wherein the system comprises:
a label disposed between the housing and the access controller, wherein the label comprises an information relating to the packaging.

10. The system as claimed in claim 1, wherein, the housing comprises a tie, wherein the tie and the lock define a pawl-ratchet mechanism, wherein the tie is operable to be moved in a first direction to secure the opening, and the tie is operable to be moved in a second direction to allow access to the opening upon the release of the lock.

11. The system as claimed in claim 10, wherein:
the tie extends from the housing, wherein the tie comprises a plurality of ridges on its surface to define a ratchet of the pawl-ratchet mechanism;
the lock comprises:
a first part that is defined on the housing;
a second part that is configured to be releasably coupled to the first part, wherein upon engagement of the second part with the first part, a passage is formed between the first part and the second part; and
a locking member is formed on an inner surface of the passage formed between the first part and the second part to define a pawl of the pawl-ratchet mechanism; and
an aperture is defined on the housing in a manner that the aperture is aligned with the passage formed between the first part and the second part.

12. The system as claimed in claim 11, wherein:
the second part is integrally defined on the access controller, wherein the access controller is configured to be releasably coupled to the first part via the second part to define the lock, wherein the passage is formed between the second part and the first part upon engagement of the access controller with the first part.

13. The system as claimed in claim 1, wherein:
the housing comprises:
a first panel; and
a second panel connected to the first panel, wherein:
the first panel comprises at least a pair of protrusions protruding from a surface of the first panel towards the second panel;
the second panel is configured to receive the access controller;
the second panel is configured to assume positions comprising an open position and a closed position, wherein:
in the open position, the second panel enables access to the protrusions;
in the closed position, the second panel prevents access to the protrusions;
the packaging comprises a pair of eyelets configured to receive the protrusions, wherein the opening of the packaging is secured by engaging the eyelets of the packaging with the protrusions and flipping the second panel pivotally towards the first panel to assume the closed position; and
the access controller is coupled to the second panel in the closed position, wherein the second panel is configured to be moved to the open position only upon disengagement of the access controller from the second panel.

14. The system as claimed in claim 1, wherein the system comprises:
an NFC (near field communication) tag;
an NFC enabled device comprising a GPS module, wherein the NFC enabled device is placed in close proximity to the NFC tag and is in communication with the NFC tag to collect information from the NFC tag; and
a server that is in communication with the NFC enabled device, wherein the server is configured to receive geographical information from the GPS module and the NFC tag information from the NFC enabled device.

15. The system as claimed in claim 14, wherein:
the movement of the NFC enabled device away from the NFC tag breaks the communication between the NFC enabled device and NFC tag; and
the server records the break in communication between the NFC enabled device and the NFC tag to raise an alarm.

16. The system as claimed in claim 1, wherein:
the security member comprises a pattern that is configured to be digitally scanned;
the housing is defined as a hinge comprising:
a first plate and a second plate hinged with each other along an edge, wherein the lock is configured to lock the first plate and the second plate;
an external reference is disposed on the housing, wherein the external reference is at a first spatial orientation with respect to the pattern when the access controller is the active position;
the access controller:
is engaged to an exterior surface of the first plate in a manner that the security member is disposed between an exterior surface of the first plate and the access controller; and
is made using a transparent material such that the pattern on the security member is visible through the access controller, wherein:
the movement of the access controller from the active position to the inactive position enables the release of the lock and causes a change in the spatial orientation between the pattern and the external reference to a second spatial orientation.

17. The system as claimed in claim 1, wherein:
the housing comprises a male unit and a female unit, wherein the male unit is configured to be coupled to the female unit to define a closed space;
the access controller is engaged to the housing, wherein the disengagement of the access controller enables the male unit and the female unit to be disengaged to access the opening of the packaging.

18. The system as claimed in claim 1, wherein a non-clonable security label is engaged to the packaging which is linked with the security member.

19. A reusable system for securing packaging and providing tamper evidence, the system comprising:
a tie tag device, wherein the device comprises:
a tag comprising a first portion, wherein the first portion defines a first slot and a first locking clip;
a tie comprising a plurality of ridges and a second portion, wherein the second portion defines a second slot and a first recess, wherein:
the tag and the tie are coupled with each other between the first portion and the second portion by the interlocking of the first locking clip and the first recess, wherein the upon engagement of the tag and the tie the first slot and the second slot align with each other to define a receiving space for receiving a free end of the tie; and
a locking member is formed on an inner surface of the receiving space formed between the first slot and the second slot, wherein the ridges on the tie interlock with the locking member on the receiving space to prevent the tie traversing out of the receiving space; and
a security member engaged to the device upon engagement of the tag and the tie, wherein the disengagement of the tag and the tie causes change in the security member, wherein the change is capable of detecting tampering.

20. A tamper evident packaging system, the system comprises:
a packaging defined as a box to hold an item, wherein the packaging comprises an opening side that is configured to provide access into the packaging, the opening side comprises:
a first closing flap comprising a first cut-out portion, wherein a first ledge is defined on the inner side of the peripheral portion of the first cut-out portion; and
a second closing flap comprising a second cut-out portion, wherein a second ledge is defined on the inner side of the peripheral of the second cut-out portion, wherein when the first closing flap is coplanar with the second closing flap, the first cut-out portion and the second cut-out portion aligns with each other to define a receiving space that enables access to an interior volumetric region of the packaging; and
a security member comprising a pattern, wherein the security member is received within the receiving space and is sandwiched between the item that is inside the interior volumetric region of the packaging, and the first ledge and the second ledge, wherein the perimeter of the receiving space is smaller than the perimeter of the security member thereby preventing the movement of the security member; and
an external reference is disposed on a surface that is independent of the security member, wherein the external reference is at a first spatial orientation with respect to the pattern.

21. The system as claimed in claim 20, wherein the system comprises:
a video capturing device, wherein the video capturing device is configured to capture a video of the packaging; and
a server that is in communication with the video capturing device, wherein the server receives the video captured by the video capturing device for auditing.

22. The system as claimed in claim 20, wherein the packaging comprises a double-flapped closing side on bottom opposite to the opening side on top, the closing side on bottom comprises:
a third extended fold on its one side of closing flap; and
a fourth extended fold on another side of closing flap, wherein:
a portion of the third fold is bent inwardly towards the volumetric space of the packaging;
a portion of the fourth fold is bent inwardly towards the volumetric space of the packaging; and
the inwardly bent portions of the third and fourth fold are locked from the interior the volumetric space of the packaging to secure the opening from bottom.

23. A method of detecting tampering of a packaging, wherein the method comprises:
integrating the capturing of a video of the packaging along with the scanning of a security member;
capturing a video of the at least one side of the packaging being flipped in view of camera and scanning the security member using a video capturing device;
communicating the captured video of the packaging and the scanning data of the security member with a server; and
auditing the captured video the scanning data of the security member to determine tampering of the packaging.

24. A method of securing packaging and providing tamper evidence, the method comprises:
securing an opening of the packaging using a lock, wherein release of the lock enables opening of the packaging;
engaging an access controller operably with the lock, wherein the access controller is configured to assume positions comprising an active position and an inactive position, wherein,
in the active position, the lock is prevented from being released; and
in the inactive position, the lock is releasable; and
engaging a security member to the access controller, wherein the movement of the access controller from the active position to the inactive position causes change in the security member, wherein the change is capable of detecting tampering.
